(19) United States
(12) Patent Application Publication
(10) Pub. No.: US 2026/0288796 A1
(43) Pub. Date: Sep. 24, 2026

(54) Hybrid Retrieval Knowledge Base System for Responsive Multi-Turn Conversations

(71) Applicant: Oracle International Corporation, Redwood Shores, CA (US)

(72) Inventors: Priyaranjan Pattnayak, Snohomish, WA (US); Amit Agarwal, Seattle, WA (US); Hansa Meghwani, Bengaluru (IN); Hitesh Laxmichand Patel, Jersey City, NJ (US); Srikant Panda, Bangalore (IN)

(73) Assignee: Oracle International Corporation, Redwood Shores, CA (US)

(21) Appl. No.: 19/556,656

(22) Filed: Mar. 4, 2026

Related U.S. Application Data
(60) Provisional application No. 63/776,801, filed on Mar. 24, 2025.

(51) Int. Cl. G06F 16/3329; G06N 5/04

(52) U.S. Cl. CPC G06F 16/33295; G06N 5/04

(57) ABSTRACT

Techniques for hybrid retrieval using a knowledge base (KB) system for responsive multi-turn conversations are disclosed. The system evaluates user queries by generating confidence scores from comparisons against a set of predefined intents. When a confidence score falls within a high-confidence range, the system produces a predefined intent-based response. When a confidence score falls within a low-confidence range, the system retrieves a relevant KB document and generates a response by applying a language model (LM) to the query and the retrieved document.

### INCORPORATION BY REFERENCE; DISCLAIMER

Each of the following applications and any parent patent applications (provisionals, non-provisionals, international, and foreign) to which this application claims priority to, directly or indirectly, are hereby incorporated by reference in their entirety to the same extent as if fully and explicitly recited herein. Any incorporation by reference is limited such that no subject matter is incorporated that is contrary to the explicit disclosure herein. The applications being incorporated by reference include at least: U.S. Application No. 63/776,801 filed on Mar. 24, 2025.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to knowledge base (KB) systems. In particular, the present disclosure relates to KB systems that include retrieval-augmented generation (RAG).

### BACKGROUND

Retrieval-based response systems generate outputs by selecting responses from a predefined set of responses stored in a data repository. An input query is processed to determine semantic similarity between the query and stored representations of candidate responses, and one or more predefined responses are selected based on the similarity results. Such systems are commonly used in applications where responses can be prepared in advance and efficiently retrieved at runtime using similarity matching or rule-based logic. RAG systems combine information retrieval techniques with generative machine learning (ML) models by retrieving relevant data from one or more knowledge sources and supplying the retrieved data as contextual input to the ML model.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIGS. 2A-2C illustrate an example set of operations for a hybrid retrieval KB system for responsive multi-turn conversations in accordance with one or more embodiments;

FIGS. 3A-3D illustrate an example embodiment for a set of operations for a hybrid retrieval KB system for responsive multi-turn online conversations in accordance with one or more embodiments;

FIG. 4 illustrates an ML engine 400 in accordance with one or more embodiments;

FIG. 5 illustrates the operation of an ML engine in one or more embodiments; and

FIG. 6 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. HYBRID RETRIEVAL KNOWLEDGE BASE SYSTEM FOR RESPONSIVE MULTI-TURN CONVERSATIONS
3. CONVERSATIONAL QUERY PROCESSING USING A HYBRID
RETRIEVAL KNOWLEDGE BASE SYSTEM
4. EXAMPLE EMBODIMENT
5. MACHINE LEARNING ARCHITECTURE
6. GENERATIVE MODELS
7. PRACTICAL APPLICATIONS, ADVANTAGES, AND IMPROVEMENTS
8. COMPUTER NETWORKS AND CLOUD NETWORKS
9. MICROSERVICE APPLICATIONS
10. HARDWARE OVERVIEW
11. MISCELLANEOUS; EXTENSIONS

### 1. General Overview

One or more embodiments include a KB system that generates responses to queries using predefined responses or RAG, depending on properties of the queries. Embodiments compute confidence scores that indicate how to handle the respective queries. Specifically, for high-confidence queries, embodiments generate responses based on predefined responses. For low-confidence queries, embodiments generate responses using RAG. Some embodiments also include one or more intermediate confidence ranges.

More specifically, one or more embodiments generate a first confidence score based on comparing a first user query with a set of intents. Confidence scores reflect a similarity between the query and the set of intents that correspond to predefined responses. The system determines that the first confidence score is in a high-confidence range and generates a first response to the first user query based on a first predefined response. Furthermore, the system generates a second confidence score based on comparing a second user query with the set of intents. The system determines that the second confidence score is in a low-confidence range and generates a second response to the second user query by applying a language model (LM) to the second user query and a first KB document. Furthermore, the system generates a third confidence score based on comparing a third user query with the set of intents. The system determines that the third confidence score is in an intermediate-confidence range. The system generates a first candidate response based on a second predefined response and generates a second candidate response by applying the LM to the third user query and a second KB document. The system generates a third response to the third user query at least by applying the LM to the first candidate response, the second candidate response, and data indicative of a blending weight based on the third confidence score.

One or more embodiments described in this Specification and/or recited in the claims may not be included in this General Overview section.

### 2. Hybrid Retrieval Knowledge Base System for Responsive Multi-Turn Conversations

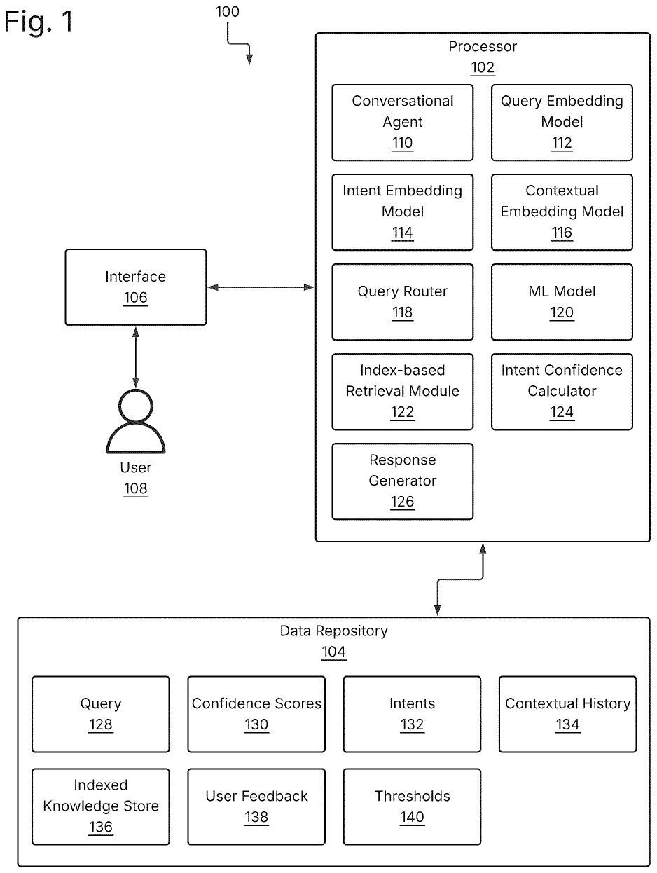

FIG. 1 illustrates a system 100 in accordance with one or more embodiments. As illustrated in FIG. 1, system 100 includes processor 102, data repository 104, interface 106, and user 108. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

In one or more embodiments, processor 102 includes conversational agent 110, query embedding model 112, intent embedding model 114, contextual embedding model 116, query router 118, machine learning (ML) model 120, index-based retrieval model 122, intent confidence calculator 124, and response generator 126. The processor 102 is configured to execute computer-readable instructions to perform the operations described herein. The processor 102 includes physical computing circuitry, including one or more hardware processing units and associated memory, that is configured to execute machine-readable instructions to perform the disclosed operations. The processor 102 may coordinate multiple functional components, including query processing, retrieval, prompt construction, and response generation, by controlling data flow between the data repository 104 and other elements within system 100. The processor 102 may execute one or more ML models, retrieval algorithms, or rule-based logic. The processor 102 may selectively invoke one or more of these components based on operating conditions. The processor 102 may use general-purpose hardware, specialized hardware, or a combination thereof, and may operate in conjunction with the data repository 104 used in performing the disclosed techniques.

In one or more embodiments, the data repository 104 is any type of storage unit and/or device (e.g., a file system, database, collection of tables, or any other storage mechanism) for storing data. Furthermore, the data repository 104 may include multiple different storage units and/or devices. The multiple different storage units and/or devices may or may not be of the same type or located at the same physical site. Furthermore, the same computing system may implement or execute the data repository 104 and processor 102. Additionally, or alternatively, separate computing systems may implement or execute the data repository 104 and processor 102. The data repository 104 may be communicatively coupled to processor 102 via a direct connection or via a network. Furthermore, data sets illustrated within the data repository 104 may be implemented across any of components within the system 100 in a decentralized and/or distributed manner. The data sets are illustrated within the data repository 104 for purposes of clarity and explanation. In one or more embodiments, the data repository 104 stores a query 128, confidence scores 130, intents 132, contextual history 134, an indexed knowledge store 136, user feedback 138, and thresholds 140.

In one or more embodiments, the interface 106 facilitates interaction between the user 108 and the system 100 by presenting information and receiving user input. The interface 106 may display generated responses, retrieved data items, confidence indicators, or other explanatory information associated with outputs from system 100. The interface 106 may further present prompts requesting user input, feedback, or confirmation. The prompts may include controls for submitting queries, refining search criteria, or selecting among alternative responses. The interface 106 may transmit user input to the processor 102 and may use it to influence subsequent processing.

In one or more embodiments, user 108 interacts with the system through the interface 106 to engage in a conversational exchange. The user 108 may submit one or more queries, follow-up queries, or clarifying inputs via the interface 106 as part of an ongoing interaction. In response, system 100 may provide corresponding responses. The conversational interaction may include contextual continuity across multiple turns, so prior queries or other user inputs are considered when processing subsequent queries. The user 108 may provide user feedback 138 through the interface 106, and the system 100 may utilize the user feedback 138 to refine subsequent processing. The user 108 may represent a human user, an automated client, or another computing entity operating through the interface 106.

In one or more embodiments, conversational agent 110 conducts dialog-based interactions with the user 108 by receiving user inputs, maintaining conversational context, and generating responsive outputs. The conversational agent 110 may manage multi-turn exchanges by tracking prior queries, responses, and contexts. The conversational agent 110 may coordinate with various backend components, such as models within processor 102 and data repository 104, to produce contextually appropriate replies. The conversational agent 110 may include dialog management logic to generate responses relevant to the current state of interaction. The conversational agent 110 may adapt its behavior based on user feedback 138, contextual history 134, and other retrieved or generated information to support coherent, continuous conversation over time. The conversational agent 110 may operate through the interface 106 or other communication channels and may support synchronous or asynchronous conversational interactions.

In one or more embodiments, query embedding model 112 is an ML model configured to transform an input query 128 into a fixed-length numerical representation, e.g., a semantic embedding, that captures semantic meaning and intent. For example, the system may implement the query embedding model 112 using a Bidirectional Encoder Representations from Transformers (BERT)-based neural network that encodes the query 128 into a contextualized vector representation. The semantic embedding enables semantically related items to be identified based on distance or similarity. The query embedding model 112 may process textual, structural, or multi-modal query inputs and generate embeddings for comparison against other embeddings stored in data repository 104. The system may use the query embeddings generated by the query embedding model 112 to perform similarity-based retrieval without requiring direct word matching. The query embedding model 112 may incorporate contextual signals, such as prior user interactions, to generate context-based embeddings that reflect conversational continuity.

In one or more embodiments, intent embedding model 114 is an ML model configured to transform intents 132 stored in the data repository 104 into fixed-length numerical representations based on the query 128. The intent embedding model 114 encodes intent-based predefined responses into a vector space. The intent embedding model 114 generates one or more predefined response embeddings that are subsequently compared to the query embedding. Similarities between the query embedding and the predefined intent embeddings are used to identify confidence scores 130 that determine a processing path for the query 128.

In one or more embodiments, contextual embedding model 116 is an ML model configured to process the encoded query representation output from query embedding model 112 with contextual history 134 associated with prior interactions. The contextual embedding model 116 receives the encoded query and one or more representations of contextual history 134, such as embeddings of prior queries, responses, or other context. Subsequently, the contextual embedding model 116 encodes the contextual history 134 and generates a context-enriched query by appending the encoded contextual history 134 with the encoded query. By considering information in both forward and backward directions, the contextual embedding model 116 integrates the contextual history 134 with the encoded query representation. The contextual embedding model 116 may also track contextual history 134 and, for multi-turn interactions, dynamically compute the embeddings based on new entries. The system may implement the contextual embedding model 116 using a bi-encoder, a cross-encoder, or a combination thereof. A bi-encoder independently encodes inputs into vector representations suitable for similarity-based comparison. A cross-encoder jointly processes paired inputs to generate an enriched representation. The contextual embedding model 116 may use the bi-encoder for efficient retrieval and the cross-encoder for subsequent refinement.

In one or more embodiments, query router 118 selectively routes the query 128 to one of multiple processing paths based on an output of the intent confidence calculator 124. The outputs of the query embedding model 112, intent embedding model 114, and contextual embedding model 116 may determine the confidence scores 130 utilized by the intent confidence calculator 124. The query router 118 may include a multi-way switch that utilizes conditional logic, decision tree, or other switching mechanism. The query router 118 enables flexible handling of queries by dynamically selecting processing paths suited to different query types.

In one or more embodiments, ML model 120 is configured to process input data and produce one or more outputs based on learned parameters. The ML model 120 may receive inputs in the form of feature vectors, embeddings, signals, or other representations and may perform various operations, such as transformation, classification, scoring, or prediction. The inputs may be in the form of a prompt that includes one or more instructions, queries, and/or contextual information. The ML model 120 receives the prompt as an input and processes the prompt to generate an output based on the included content. In RAG systems, the prompt may further include retrieved data items or excerpts from an indexed knowledge store 136. The retrieved content provides external information that supplements model parameters during processing. The ML model 120 generates an output conditioned on both the prompt content and the retrieved data items. Embodiments may train the ML model 120 using supervised, unsupervised, or self-supervised learning techniques and may operate on structured or unstructured data.

In one or more embodiments, index-based retrieval module 122 is configured to retrieve data from the indexed knowledge store 136 within data repository 104 using an index that enables efficient lookup based on one or more query representations. In particular, the index-based retrieval module 122 may receive a query representation and perform similarity-based, keyword-based, or hybrid matching against indexed representations of stored data items in the indexed knowledge store 136. The index-based retrieval module 122 may access one or more index structures, including inverted indexes, vector indexes, or graph-based indexes, to identify candidate data items. Embodiments may rank, filter, or otherwise process retrieved data items before providing them to downstream components. The index-based retrieval module 122 enables scalable and efficient retrieval by leveraging precomputed index structures associated with the indexed knowledge store 136. Furthermore, the index-based retrieval module may incorporate the use of the ML model 120 to refine retrieval results, adjust ranking based on relevance patterns, or generate meaningful outputs for downstream components. The ML model may operate in conjunction with the index to improve retrieval accuracy or efficiency.

In one or more embodiments, intent confidence calculator 124 compares the query 128 with one or more intents 132 stored in data repository 104. The system may perform the comparison against individual intents 132 or batches of intents 132. The system 100 may perform pre-processing to limit the number of intents 132 transmitted to the intent confidence calculator 124 for comparison with the query 128. Prior to comparison, the system may embed the query 128 with relevant contextual history 134 by the contextual embedding model 116. The system uses cosine similarity to compute similarity scores between vector representations of the query 128 and respective intents 132. In particular, the system may measure the angular similarities between respective vectors in a vector space. Additionally, or alternatively, the system may use other comparison methods, including dot product similarity, Euclidean distance, Manhattan distance, or learned similarity functions. Upon determining confidence scores based on comparisons between the query 128 and intents 132, the system may identify a maximum confidence score of the confidence scores. The maximum confidence score corresponds to a respective intent of the intents 132 and the system may compare the maximum confidence score to one or more thresholds 140. The system may use the result of the comparison to drive the selection of the query router 118 and/or other components in system 100.

In one or more embodiments, response generator 126 generates a response to the query 128 that is subsequently displayed to the user 108 on interface 106 and stored as contextual history 134 for future usage. The response generator 126 may utilize inputs from various components in processor 102 to determine the response. The response generator 126 may pass through an input as the responses without additional processing. Additionally, or alternatively, the response generator 126 may perform processing of varying degrees on a generated response, ranging from minimal formatting or validation to more substantial modification, prior to outputting the response. Furthermore, the response generator 126 may include an ML model to generate the response. The response generator 126 may trigger specific functionality of the ML model based on the number and types of inputs received. For example, if the response generator 126 receives a predefined response based on one or more intents 132, the response generator 126 may transmit the predefined response to the user 108 without modification. However, if the response generator 126 receives a response generated from ML model 120 in addition to the predefined response, the response generator 126 may utilize the integrated ML model to generate a combined response based on both inputs. The response generator 126 may assign weights to both inputs. The weights may indicate a relative importance of the inputs and by adjusting the weights, the response generator 126 may influence how strongly a respective input contributes to the combined response.

In one or more embodiments, query 128 represents an input provided by user 108 using interface 106. The query 128 may include natural language text, keywords, or other input data intended to request information or initiate processing by the system. As part of an ongoing conversational interaction, the system may interpret the query 128 in view of prior queries, responses, or contextual information. The query 128 may also be associated with a query embedding generated from the query 128. The query embedding may represent semantic characteristics of the query in a vector form suitable for downstream processing. The query embedding may integrate contextual history 134 from prior interactions to reflect conversational continuity. The query 128 is provided to processor 102 for analysis, routing, retrieval, or response generation.

In one or more embodiments, confidence scores 130 reflect a similarity between the query 128 and intents 132 that correspond to predefined responses. The confidence scores 130 are calculated by comparing the query embedding with predefined intent embeddings by applying similarity or distance functions to the vector representations. The system may represent the confidence scores 130 as numerical values with a normalized range from 0 to 1 with values closer to 1 indicating higher confidence. After generation, the confidence scores 130 are compared to one or more thresholds 140 to classify the query 128 for further processing.

In one or more embodiments, the intents 132 represent a predefined set of intent categories associated with corresponding responses to user queries. The system may individually link the intents 132 to a predefined response or response template that is selected when a query 128 is mapped to the stored intent. The system may encode and store the intents 132 as vector representations alongside corresponding plain-English descriptions or labels of the intents 132. The system may use plain-English intents for response generation, whereas the system may use the vector representations for similarity-based matching with query representations. Furthermore, the system may update the intents 132 based on user feedback 138. Such updates may include modifying intent definitions, adjusting associated vector representations, or revising predefined responses to improve alignment with user interactions. The system may create new intents 132 for recurring queries and responses that do not correspond to the predefined intent categories.

In one or more embodiments, contextual history 134 represents information associated with prior interactions between the user 108 and the system 100. The contextual history 134 may include previous queries, generated responses, selected intents, user feedback, timestamps, or other contextual interaction metadata. The system may store and reference the contextual history 134 when processing subsequent queries to support conversational continuity and informed response generation. The system may encode the contextual history 134 into one or more representations that are integrated with query processing to reflect the state of an ongoing interaction and generate more accurate responses to subsequent queries.

In one or more embodiments, indexed knowledge store 136 maintains information in association with one or more index structures to enable efficient access by index-based retrieval module 122 and/or the ML model 120 in a RAG system. The indexed knowledge store 136 may store documents, past incident reports, or other data items together with indexed representations, such as embeddings or keywords, that support similarity-based or keyword-based retrieval. During operation, an ML model 120, via the index-based retrieval module 122, retrieves relevant data items from the indexed knowledge store 136 based on a query representation and incorporates the retrieved data into downstream processing.

In one or more embodiments, the system may collect user feedback 138 corresponding to responses to a query 128 to assess the relevance or accuracy of the generated responses. The user feedback 138 may include explicit inputs, such as ratings, corrections, or selections. The system may also collect explicit user feedback 138 via a post-response prompt generated by conversational agent 110 on interface 106. Specifically, the prompt may include one or more indicators presented on the interface 106, such as thumbs up and thumbs down icons, that allow the user 108 to rate the response as positive or negative. The user 108 may input the user feedback 138 via interface 106. Additionally, or alternatively, the user feedback 138 may include implicit feedback such as query refinements. The system may use the user feedback 138 to refine one or more thresholds 140, intents 132, and responses output from response generator 126. In particular, the system 100 may tally an amount of user feedback 138 to determine aggregate performance and, upon reaching a threshold number of tallies, adjust one or more thresholds 140.

In one or more embodiments, thresholds 140 are applied to confidence scores 130 associated with query processing. The one or more thresholds 140 establish ranges to classify the confidence scores 130 with the ranges corresponding to one or more processing paths for a given query 128. For example, if a confidence score 130 is higher than one or more thresholds 140, the system may provide a predefined response associated with an intent 132 corresponding to the confidence score 130 as a response to a query 128. Conversely, if a confidence score 130 is lower than one or more thresholds 140, the system may provide the query 128 to an ML model 120, utilizing the index-based retrieval module 122, and provide the output of the ML model 120 as a response to the query 128. Furthermore, the system 100 may determine one or more intermediate processing paths for query 128. For example, if a confidence score 130 falls between two thresholds 140, the system 100 may utilize both the output of the ML model 120 and a predefined response associated with an intent 132 to further determine a combined response to the query 128. The system 100 may determine one or more confidence ranges based on the one or more thresholds 140. For example, the system may determine a high confidence range above a first threshold higher than a second threshold, an intermediate confidence range between the first threshold and the second threshold, and a low confidence range below the second threshold.

In an embodiment, processor 102, data repository 104, and interface 106 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, the interface 106 between user 108 and processor 102 refers to hardware and/or software configured to facilitate communications between a user 108 and processor 102. The interface 106 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 106 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 106 is specified in one or more other languages, such as Java, C, or C++.

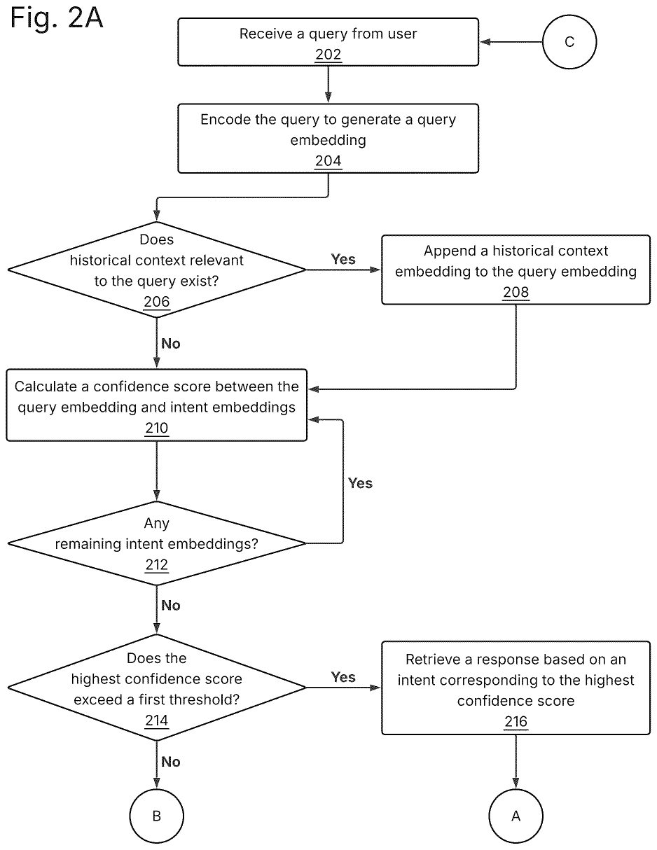

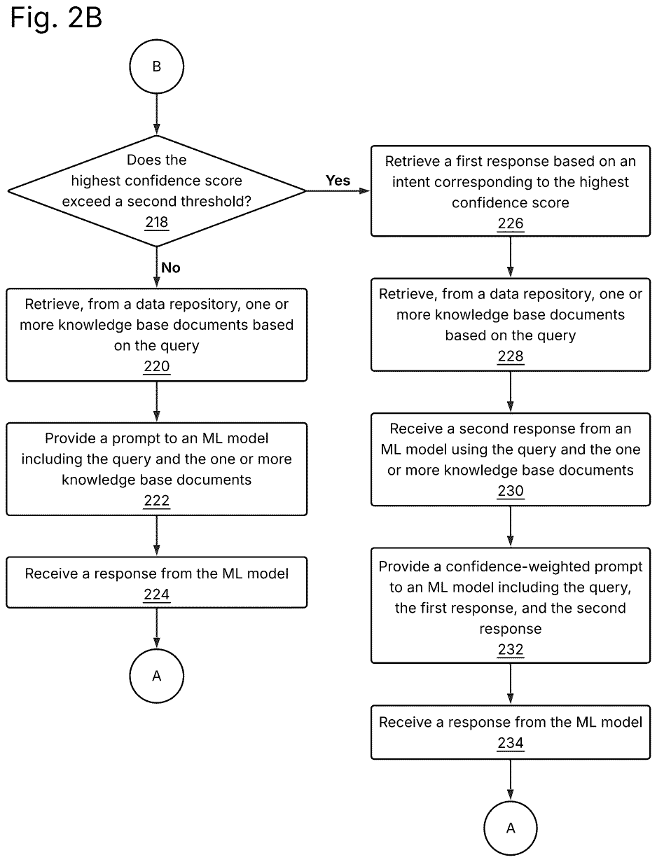

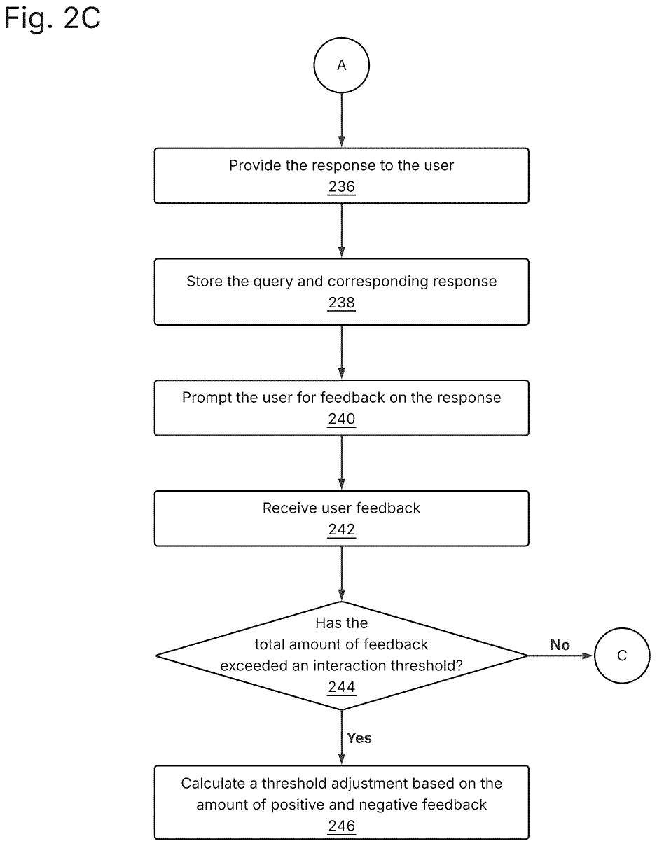

In one or more embodiments, system 100 refers to hardware and/or software configured to perform operations described herein for conversational query processing using a hybrid retrieval KB system. Examples of operations for conversational query processing using a hybrid retrieval KB system are described below with reference to FIGS. 2A-2C.

### 3. Conversational Query Processing Using a Hybrid Retrieval Knowledge Base System

FIGS. 2A-2C illustrate an example set of operations for conversational query processing using a hybrid retrieval KB system in accordance with one or more embodiments. One or more operations illustrated in FIGS. 2A-2C may be modified, rearranged, or omitted. Accordingly, the particular sequence of operations illustrated in FIGS. 2A-2C should not be construed as limiting the scope of one or more embodiments.

One or more embodiments receive a query from a user (Operation 202). The system may receive a query from a user via an interface, such as a GUI, as an input requesting information. The user may provide the query in natural language, structured text, or another supported format, and may include keywords, phrases, questions, or commands. Upon receipt, the system may log and/or preprocess the query to remove noise, detect language, or extract relevant features. The query may be part of an ongoing conversation between the user and the system. In such cases, the system may interpret the query in view of prior queries, responses, or contextual history associated with the conversation.

One or more embodiments encode the query to generate a query embedding (Operation 204). The query embedding may represent semantic characteristics of the query in a vector form. An ML model may perform the encoding operation to process the query text to produce a fixed-length numerical representation. For example, the system may generate the query embedding by encoding the query using a BERT-based neural network model. The BERT-based model produces a contextualized vector representation that captures semantic relationships among terms in the query. For query Q, the query embedding E_{q}=BERT(Q). The system may store the resulting query embedding with the query and use the query embedding for downstream operations. By transforming the query into an embedding, the system enables processing that is independent of exact lexical matching.

One or more embodiments determine if historical context relevant to the query exists (Operation 206). The system may determine if historical context exists by evaluating information associated with prior interactions between the user and the system. The evaluation may include identifying if a conversational session is active, if prior queries or responses are available, and if stored contextual history satisfies one or more relevance criteria with respect to the current query. The system may consider historical context between the system and an active user. Additionally, or alternatively, the system may consider historical context irrespective of the user's own interaction with the system. The system may compute a relevance score between a representation of the query and one or more representations of historical context and compare the relevance score to a threshold to determine if the historical context is applicable.

If the historical context relevant to the query exists, one or more embodiments append a historical context embedding to the query embedding (Operation 208). The system may incorporate at least a portion of the historical context into subsequent processing, such as routing and/or response generation. The historical context embedding tracks dialogue history, stored in a sliding window, using embeddings of prior queries and responses for faster retrieval. For multi-turn interactions, the historical context embedding is computed as Hₜ=ψ(Qₜ₋ᵢ, Rₜ₋ᵢ)|i=1, . . . , n}), where ψ represents a bi-encoder that computes the embeddings by appending prior context, queries, and responses into a string. Qₜ₋ᵢ and Rₜ₋ᵢ represent previous queries and corresponding responses. The aggregated historical context Hₜ is used to compute the contextual query embedding Contextt=φ(E_{q}, Hₜ). The system may append the historical context embedding to the query embedding to form a combined representation used for downstream processing. The historical context embedding may represent prior queries, responses, or interaction state associated with a conversation. The system may generate the historical context embedding independent of the current query embedding. Appending the historical context embedding may include concatenating the embeddings, merging them into a unified vector, or otherwise associating the embeddings to preserve information from both the current query and the historical context. The system may use the resulting combined representation to incorporate conversational continuity into query processing.

Once the system either appends the historical context embedding to the query embedding or determines that the historical context relevant to the query does not exist, one or more embodiments calculate a confidence score between the query embedding and intent embeddings (Operation 210). For a set of intent embeddings {E₁, E₂, . . . , Eₙ), the system calculates a cosine similarity between the query Q and a respective intent embedding Et. The system determines a set of confidence scores:

$${c}_{i} = ( Q * {E}_{i} ) / ( ‖ Q ‖ * ‖ {E}_{i} ‖ ) for i = 1 , … , n .$$

In the case where the system appended historical context to the query, the system determines a set of confidence scores:

$${c}_{i} = ( {Context}_{t} * {E}_{i} ) / ( ‖ {Context}_{t} ‖ * ‖ {E}_{i} ‖ ) for i = 1 , … , n .$$

Subsequently, the system determines a highest confidence score cₘₐₓ=max (cᵢ), corresponding to Intentₘₐₓ. The system outputs cₘₐₓ and Intentₘₐₓ for downstream processing. If the system determines that remaining intents i that have not been compared to the query Q, one or more embodiments iterate over intent i from 1 to n to evaluate a confidence score for the corresponding vector E; (Operation 212).

Upon determining that the intent embeddings have been compared to the query embedding, one or more embodiments determine if the highest confidence score cₘₐₓ exceeds a first threshold (Operation 214). The system compares cₘₐₓ to a threshold value within a range from 0 to 1. For example, the first threshold may be set to 0.85. As such, when cₘₐₓ is greater than 0.85, the threshold condition is determined to be satisfied. By determining that the threshold condition is met, the system concludes that the predefined response corresponding to the stored intent sufficiently answers the user's query. As addressed below, the threshold may be predefined or dynamically adjusted over time based on explicit and/or implicit user feedback.

Upon determining that the highest confidence score cₘₐₓ exceeds the first threshold, one or more embodiments retrieve a predefined response based on an intent corresponding to the highest confidence score cₘₐₓ (Operation 216). As defined above, intent Intentₘₐₓ corresponds to the highest confidence score cₘₐₓ, and the retrieved predefined response is associated with intent Intentₘₐₓ. The system determines that the predefined response corresponding to intent Intentₘₐₓ answers the user's query without further modification or analysis. The predefined response is selected as a response to be passed directly to the user for rapid query resolution. The step of providing the response to the user is described below with respect to operation 236.

Upon determining that the highest confidence score cₘₐₓ does not exceed the first threshold, one or more embodiments determine if the highest confidence score cₘₐₓ exceeds a second threshold (Operation 218). The system may define the second threshold lower than the first threshold and establish, in conjunction with the first threshold, one or more ranges in which the highest confidence score may fall. For example, the second threshold may be set to 0.5, so the three ranges are established as follows: (1) cₘₐₓ>0.85, (2) 0.5<cₘₐₓ≤0.85, and (3) cₘₐₓ≤0.5. As explained above, if cₘₐₓ>0.85, the system determines that a predefined response corresponding to Intentₘₐₓ answers the user's query. If cₘₐₓ≤0.5, the system determines that the Intentₘₐₓ with the closest similarity to the query is different enough to be deemed out of the query's domain and, thus, relies on a RAG system to determine the response.

Upon determining that the highest confidence score cₘₐₓ does not exceed a second threshold, one or more embodiments retrieve, from a data repository, one or more knowledge base documents based on the query (Operation 220). The system determines that the query should be input into a RAG system to determine a response based on information retrieved from the data repository. The system may retrieve the information by comparing a representation of the query to indexed representations of information stored in the data repository to identify knowledge base documents relevant to the query. The retrieval may be based on lexical search, semantic search, or a combination of both. Lexical search may match query terms to document text, whereas semantic search may compare vector representations of the query and documents to identify semantically related content. The retrieved knowledge base documents may include full documents, passages, or other content.

One or more embodiments provide a prompt to an ML model (Operation 222). The prompt includes the query and the one or more knowledge base documents. The system may construct the prompt by combining the query with selected portions of the retrieved knowledge base documents in a structured format suitable for ML model processing. The prompt may further include instructions and/or delimiters that distinguish the query from the retrieved content. By providing the prompt to the ML model, the RAG system enables the ML model to generate a response to the query that is informed by both the query and the retrieved knowledge base documents.

One or more embodiments receive a response from the ML model (Operation 224). The response may include natural language text and/or other output content corresponding to the query and any associated retrieved information. Upon receipt, the system may provide the response to downstream components for further processing or output. The step of providing the response to the user is described below with respect to operation 236.

Upon determining that the highest confidence score cₘₐₓ exceeds a second threshold, one or more embodiments retrieve a first response based on an intent corresponding to the highest confidence score (Operation 226). Using the example ranges from above, if the system determines that 0.5<cₘₐₓ≤0.85, the system classifies the query as requiring a contextual response that utilizes both the predefined response and ML model generated response. Thus, the system retrieves the predefined response corresponding to Intentₘₐₓ as a first response. Rather than being output to the user as a response to the query, the system retrieves the first response for subsequent processing.

One or more embodiments retrieve, from a data repository, one or more knowledge base documents based on the query (Operation 228). The system inputs the query to a RAG system to determine a second response based on information retrieved from the data repository. The system may retrieve the information by comparing a representation of the query to indexed representations of information stored in the data repository to identify knowledge base documents relevant to the query. The retrieval may be based on lexical search, semantic search, or a combination of both. Lexical search may match query terms to document text, whereas semantic search may compare vector representations of the query and documents to identify semantically related content. The retrieved knowledge base documents may include full documents, passages, or other content.

One or more embodiments receive a second response from an ML model using the query and the one or more knowledge base documents (Operation 230). The system may construct a prompt for the ML model by combining the query with selected portions of the retrieved knowledge base documents in a structured format suitable for ML model processing. The prompt may further include instructions and/or delimiters that distinguish the query from the retrieved content. By providing the prompt to the ML model, the RAG system enables the ML model to generate a second response to the query that is informed by both the query and the retrieved knowledge base documents. The second response may include natural language text and/or other output content corresponding to the query and any associated retrieved information. Rather than being output to the user as a response, the system utilizes the second response for subsequent processing.

One or more embodiments provide a confidence-weighted prompt to an ML model including the query, the first response, and the second response (Operation 232). The system may weigh the first response R₁ and second response R₂ to generate a combined response R_{c} based on the confidence score cₘₐₓ as follows: R_{c}=ML model (cₘₐₓ*R₁, (1-cₘₐₓ)*R₂). For example, if cₘₐₓ=0.7, the respective weights of the first response and second response would be 0.7*R₁ and 0.3*R₂. The system feeds both weighted responses to the ML model along with the query and prompts the ML model to generate a combined response that factors both weighted responses according to their respective weights.

One or more embodiments receive a response from the ML model (Operation 234). The ML model considers both weighted responses and generates a combined response for output to the user. The response may include natural language text and/or other output content that corresponds to the query and any associated retrieved information. Upon receipt, the system may provide the response to downstream components for further processing or output.

One or more embodiments provide the response to the user (Operation 236). Upon determining the appropriate classification for the query (based on cₘₐₓ and the one or more classification ranges) and generating a corresponding response using a predefined response and/or an ML model, the system provides the generated response to the user in response to the query. The system may present the response to the user on the interface, for example, by displaying the response in an output region of the interface.

One or more embodiments store the query and the corresponding response (Operation 238). The system stores the query and corresponding response in a data repository for subsequent reference. The system may associate the stored information with metadata, such as timestamps, user identifiers, session identifiers, confidence scores, and/or other contextual information related to the query session. The system may index the stored query and response to enable efficient retrieval during future interactions. The system may use the stored data to update models, refine thresholds, or inform response selection.

One or more embodiments prompt the user for feedback on the response (Operation 240). For example, the prompt may include one or more indicators presented on the GUI, such as thumbs up and thumbs down icons, that allow the user to rate the response as positive or negative. Positive feedback may signal that the response was accurate or helpful, whereas negative feedback may indicate dissatisfaction or error. The system may present the feedback prompt after the response is provided or as part of an ongoing interaction.

One or more embodiments receive user feedback (Operation 242). The system may receive user feedback provided in response to the feedback prompt presented after delivering a response. The feedback may include explicit indicators, such as positive or negative selections, and may be associated with the corresponding query and response. The feedback may also include implicit feedback, such as query refinements provided during an ongoing interaction. Upon receipt, the system may store and analyze the feedback to assess response quality and influence subsequent processing.

One or more embodiments determine if the total amount of feedback has exceeded an interaction threshold (Operation 244). The system may establish a threshold amount of feedback that, once exceeded, triggers an update of the one or more thresholds. The system may set the threshold amount to any number of interactions and may dynamically vary the threshold amount based on intent and/or response mapping considerations. For example, the system may update the thresholds at intervals of 100 interactions with one or more users. Subsequently, the system may increase or reduce the number of interactions required to reach the threshold amount of feedback. The system may determine that once the threshold amount of feedback is received, sufficient feedback has been received to determine if the threshold levels require adjustment.

If the system determines that the total amount of feedback has exceeded an interaction threshold, one or more embodiments calculate a threshold adjustment based on the amount of positive and negative feedback (Operation 246). The system first calculates a positive feedback rate (PFR) and a negative feedback rate (NFR). Both rates are calculated by dividing the respective amount of feedback by the total number of queries according to the following equations: PFR=amount of positive feedback/total queries, and NFR=amount of negative feedback/total queries. Subsequently, the system determines a threshold adjustment based on the PFR and NFR. If the system utilizes multiple thresholds, the system adjusts the upper threshold based on which the predefined response is generated. The new upper threshold τ_{new}=τ_{current}+λ*(NFR−PFR), where λ is a scaling factor controlling the sensitivity of the adjustment. As such, a high amount of negative feedback increases the upper threshold τ, reducing the likelihood of misclassification of predefined responses as responsive to queries. Conversely, a high amount of positive feedback lowers the upper threshold t in favor of classifying more queries in the highest classification range. The lower threshold may be kept the same. If the system determines that the total amount of feedback has not exceeded an interaction threshold, one or more embodiments return to the step of receiving a subsequent query from a user.

### 4. Example Embodiment

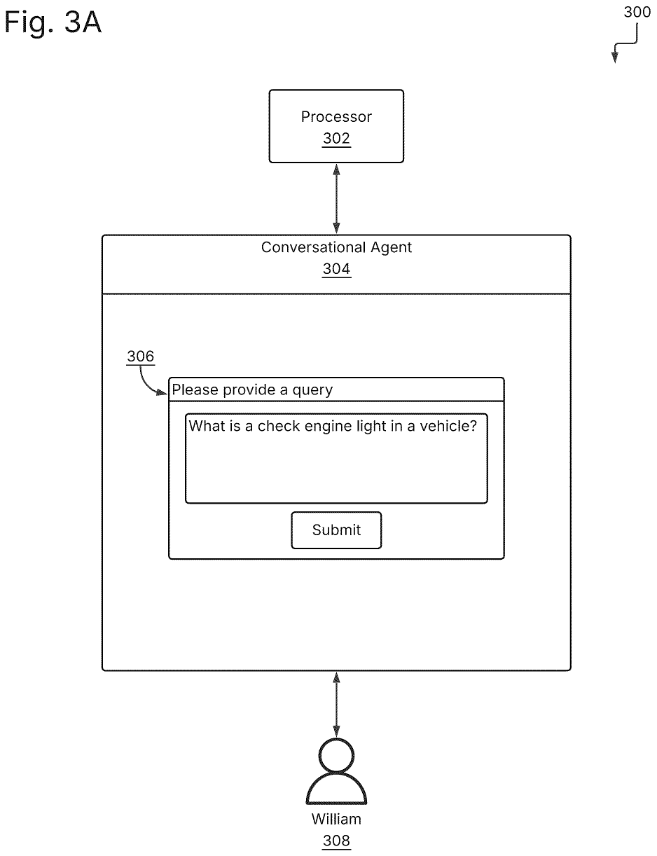

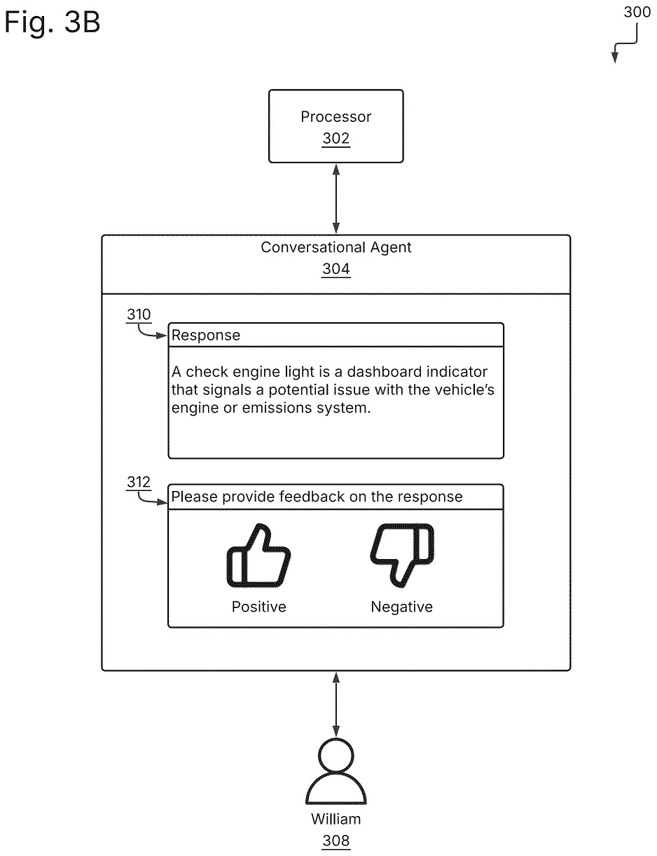

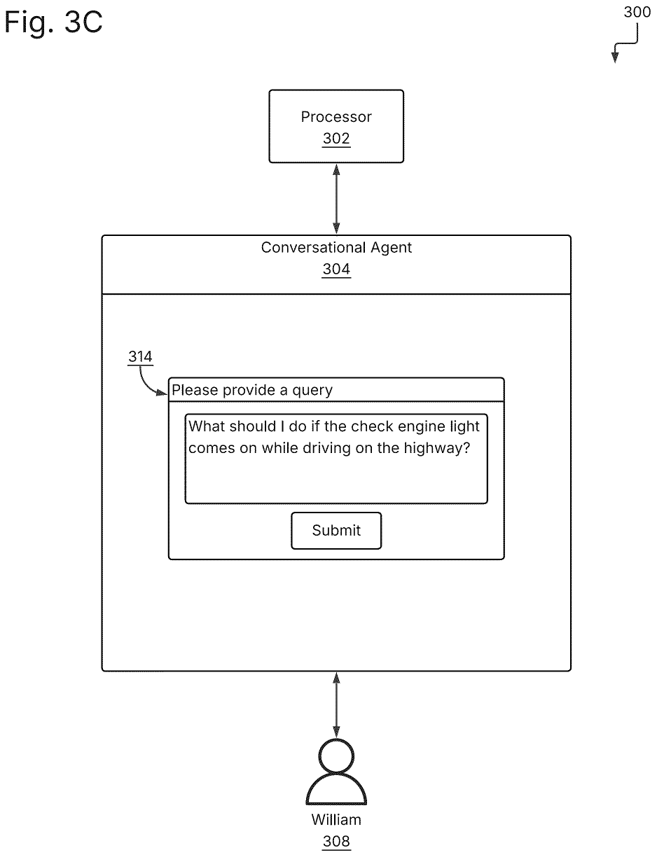

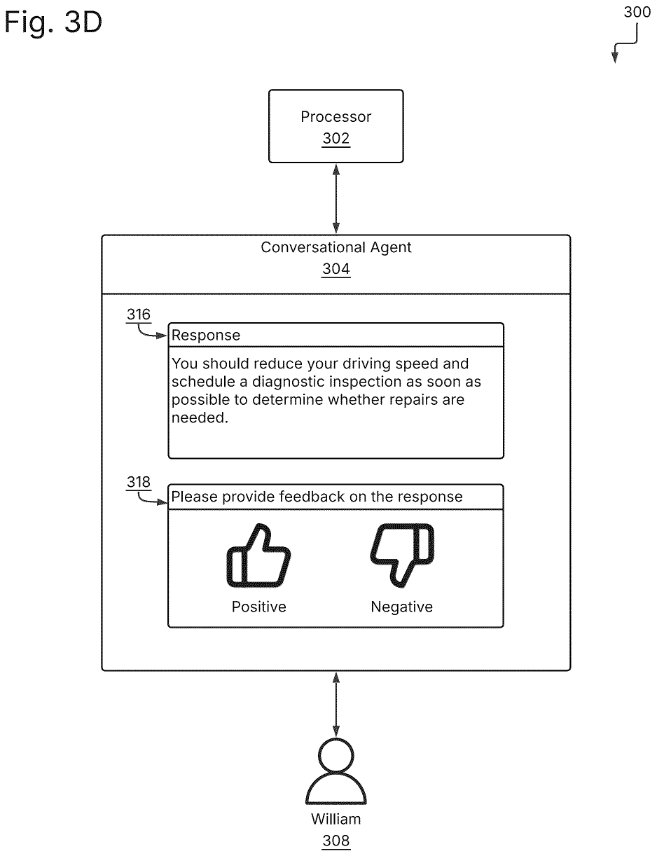

A detailed example is described with respect to FIGS. 3A-3D for purposes of clarity. Components and/or operations described below should be understood as one specific example that may not be applicable to certain embodiments. Accordingly, components and/or operations described below should not be construed as limiting the scope of any of the claims.

FIG. 3A illustrates a system 300 for responsive multi-turn conversations. The system 300 includes processor 302 that runs a hybrid conversational system that incorporates the use of RAG and intent-based predefined responses to user queries. A user 308 (named William in this example for ease of discussion), a user of the system 300, interacts with the processor 302 via a GUI of a conversational agent 304. The conversational agent 304 displays a query input window 306 that requests a query from William 308 and provides a text input area and a “Submit” button. As a first query, William 308 inputs a query asking, “What is a check engine light in a vehicle?” and submits the query by clicking “Submit.” The conversational agent 304 sends the query to processor 302 for further analysis.

The processor 302 first encodes the query to generate a query embedding. The system 300 may utilize a BERT-based neural network to encode the query into a contextualized vector representation. Next, the system 300 determines if there exists any historical context relevant to the query. For the sake of this example, the above query is the first query in a conversation, and thus, the system 300 determines that no historical context exists. Conversely, if William 308 previously interacted with the system 300, the system 300 would retrieve the logged queries and corresponding responses and append them to the query as relevant historical context.

The system 300 calculates confidence scores between the first query and stored intent embeddings by comparing the query embedding against a set of stored intent embeddings corresponding to predefined responses. The comparison is performed by computing a confidence score between the first query embedding and respective stored intent embeddings to determine a degree of semantic similarity. The system 300 may calculate, for example, a cosine similarity between the first query and the set of stored intent embeddings. Based on the computed confidence scores, one or more predefined responses having the highest similarity to the first query embedding are identified and selected for output. For example, after searching the intent database and performing the comparisons, the system 300 determines that the two highest similarity predefined responses state the following: (1) “A check engine light is a dashboard indicator that signals a potential issue with the vehicle's engine or emissions system.” and (2) “When the check engine light turns on, a vehicle owner may schedule a diagnostic inspection or maintenance service to determine whether repairs are needed.”

The system 300 assigns confidence scores to respective intents that correspond to the predefined responses. The system determines that the first response defines the concept of a “check engine light” as present in the first query, while the second response provides a recommended action. Thus, the system 300 attributes a higher confidence score to the intent corresponding to the first response. For example, the system 300 assigns a confidence score of 0.9 to the first response and 0.6 to the second response. Thus, the system 300 determines that the highest confidence score is 0.9 corresponding to the first predefined response. The system 300 compares the highest confidence score with a first threshold and a second threshold. For the sake of this example, the first threshold is set to 0.85, and the second threshold is set to 0.5. Thus, the highest confidence score of 0.9 is deemed higher than the first threshold.

As illustrated in FIG. 3B, the system 300 provides the predefined response corresponding to the first predefined answer, “A check engine light is a dashboard indicator that signals a potential issue with the vehicle's engine or emissions system.” to William 308 via the conversational agent 304. The response is presented in a response window 310. Under the response window 310, the system also displays a feedback window 312. The feedback window asks William 308 to provide his feedback on the response by clicking a “thumbs up” or “thumbs down” icon reflecting positive or negative feedback, respectively. Because the response sufficiently answered the query, William 308 clicks the “thumbs up” feedback button corresponding to positive feedback. The system 300 logs the positive feedback for future analysis.

As illustrated in FIG. 3C, the system 300 restarts the query input process and requests a second query from William 308 using query input window 314. As part of a multi-turn conversation, William 308 asks, “What should I do if the check engine light comes on while driving on the highway?” and clicks “Submit.” The system 300 inputs the second query and calculates confidence scores between the second query and stored intent embeddings by comparing the query embedding against a set of stored intent embeddings corresponding to predefined responses. The comparison is performed by computing a confidence score between the second query embedding and respective stored intent embeddings to determine a degree of semantic similarity. The system 300 may calculate, for example, a cosine similarity between the second query and the set of stored intent embeddings. Based on the computed confidence scores, one or more predefined responses having the highest similarity to the second query embedding are identified and selected for output.

The system 300 determines that the same two predefined responses from above have the highest similarity to the second query. The two predefined responses state (1) “A check engine light is a dashboard indicator that signals a potential issue with the vehicle's engine or emissions system.” and (2) “When the check engine light turns on, a vehicle owner may schedule a diagnostic inspection or maintenance service to determine whether repairs are needed.” These are determined to be similar because they both include the term “check engine light.” The first response defines the term “check engine light,” and the second response focuses on recommended action once a check engine light is turned on. However, unlike the first query, the second query asks for a recommended action “while driving on the highway.” As such, the system 300 ranks the second response higher than the first response. The first response is assigned a confidence score of 0.5, and the second response is assigned a confidence score of 0.7. The system 300 determines that the highest confidence score of 0.7 is lower than the first threshold of 0.85 but higher than the second threshold of 0.5. Thus, the system classifies the query as requiring a hybrid response that utilizes both the predefined response corresponding to the highest confidence score and an output from a RAG system.

The system 300 passes the second query to an ML model using a RAG system to determine an answer based on information stored in a data repository. The system 300 retrieves relevant information from the data repository, including one or more knowledge base documents. For example, the system 300 retrieves a technical description of conditions under which a check engine light is illuminated and a passage describing safety procedures while driving on a highway. The ML model utilizes the retrieved information as contextual input and generates an answer to the second query. The answer is informed by both the retrieved information and learned parameters of the ML model. The ML model generates the following response: “If the check engine light comes on while driving on the highway, you should stay calm, reduce speed, and avoid hard acceleration.”

In response to receiving the predefined response and the ML model generated response, the system 300 assigns weights to both responses and supplies them to an ML model based on the following equation: ML model (cₘₐₓ*R₁, (1−cₘₐₓ)*R₂), where cₘₐₓ is the highest confidence score, R₁ is the predefined response, and R₂ is the ML model generated response. Here, the weights are assigned as 0.7 for the predefined response and (1-0.7)=0.3 for the ML model generated response. The system 300 supplies both responses to an ML model with the following prompt:

You are an AI assistant tasked with synthesizing responses to a given query. You have received two distinct responses to the query, each with a specific weight. Your goal is to produce a refined and cohesive final response that
1. Gives appropriate emphasis to the response with higher weight, while considering elements from the lower-weight response if they add value or completeness.
2. Avoids contradictions and ensures clarity, consistency, and factual correctness in the final output.
3. Uses the weights to proportionally balance the contributions of each response without undermining valuable insights from either.

### Instructions:

Consider the following inputs:
   Query: What should I do if the check engine light comes on while driving on the highway?
   Response 1: When the check engine light turns on, a vehicle owner may schedule a diagnostic inspection or maintenance service to determine whether repairs are needed.
   Weight 1:0.7
   Response 2: If the check engine light comes on while driving on the highway, you should stay calm, reduce speed, and avoid hard acceleration.
   Weight 2:0.3
Combine the two responses into a single, well-structured response by prioritizing the higher-weight response while integrating any complementary information from the other response.

### Output:

Provide a single, refined response to the query. Ensure the response is logically structured, concise, and addresses the query comprehensively.

As illustrated in FIG. 3D, in response to the above prompt, the ML model generates the following response: “You should reduce your driving speed and schedule a diagnostic inspection as soon as possible to determine whether repairs are needed.” The response is displayed to William 308 in response window 316 in the conversational agent 304. Underneath the response window 316, the system 300 displays another feedback window 318. The feedback window 318 asks William 308 to provide his feedback on the response by clicking a “thumbs up” icon (reflecting positive feedback) or “thumbs down” icon (reflecting negative feedback). Because the response sufficiently answered the query, William 308 again clicks the “thumbs up” feedback button corresponding to positive feedback. The system 300 stores this feedback for future analysis.

For the sake of this example, the system 300 determines that the feedback received in feedback window 318 exceeds an interaction threshold. In response, the system 300 calculates a threshold adjustment based on the amount of positive and negative feedback. Assume that the system received, out of 100 feedback ratings, 58 responses indicating positive feedback and 42 responses indicating negative feedback. The system adjusts the first threshold τ, initially set to 0.85, based on the following equation τ_{new}=τ_{current}+λ*(NFR−PFR), where A is a scaling factor controlling the sensitivity of the adjustment, PFR=amount of positive feedback/total queries, and NFR=amount of negative feedback/total queries. Assuming the scaling factor A is set to 1, the new first threshold τ_{new}=0.85+1*(0.42−0.58)=0.69. Thus, a highest confidence score exceeding the new first threshold τ_{new} of 0.69 would trigger a predefined response. In the example above, if the highest confidence score fell below the second threshold of 0.5, the system 300 would deem the predefined response as not sufficiently relevant to William's 308 query and determine a response to the query based solely on an output of the ML model using a RAG system.

### 5. Machine Learning Architecture

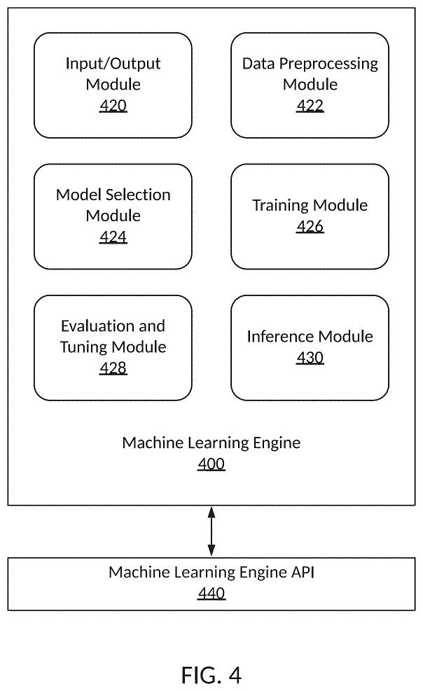

FIG. 4 illustrates a machine learning engine 400 in accordance with one or more embodiments. As illustrated in FIG. 4, machine learning engine 400 includes input/output module 420, data preprocessing module 422, model selection module 424, training module 426, evaluation and tuning module 428, and inference module 430.

In accordance with an embodiment, input/output module 420 serves as the primary interface for data entering and exiting the system, managing the flow and integrity of data. This module may accommodate a wide range of data sources and formats to facilitate integration and communication within the machine learning architecture.

In an embodiment, an input handler within input/output module 420 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 420 to be versatile in different operational contexts, whether processing historical datasets or streaming data.

In accordance with an embodiment, input/output module 420 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 420 includes an output framework designed to handle the distribution and exportation of outputs, predictions, or insights. Using the output framework, input/output module 420 formats these outputs into user-friendly and accessible formats, such as reports, visualizations, or data files compatible with other systems. Input/output module 420 also ensures secure and efficient transmission of these outputs to end-users or other systems in an embodiment and may employ encryption and secure data transfer protocols to maintain data confidentiality.

In accordance with an embodiment, data preprocessing module 422 transforms data into a format suitable for use by other modules in machine learning engine 400. For example, data preprocessing module 422 may transform raw data into a normalized or standardized format suitable for training ML models and for processing new data inputs for inference. In an embodiment, data preprocessing module 422 acts as a bridge between the raw data sources and the analytical capabilities of machine learning engine 400.

In an embodiment, data preprocessing module 422 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 422 may be configured to handle anomalies in different ways depending on context. Data preprocessing module 422 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 422 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 422 processes new data for inference, data preprocessing module 422 replicates the same preprocessing steps to ensure consistency with the training data format. This helps to avoid discrepancies between the training data format and the inference data format, thereby reducing the likelihood of inaccurate or invalid model predictions.

In an embodiment, model selection module 424 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 424 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 424 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 424 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 424 also considers computational efficiency and resource constraints. This is meant to help ensure the selected model is both accurate and practical in terms of computational and time requirements. In an embodiment, certain features of model selection module 424 are configurable such as a configured bias toward (or against) computational efficiency.

In accordance with an embodiment, training module 426 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 426 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 426 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 426 includes logic to handle different types of data and learning tasks. For instance, it includes different training routines for supervised learning (where the training data comes with labels) and unsupervised learning (without labeled data). In the case of deep learning models, training module 426 also manages the complexities of training neural networks that include initializing network weights, choosing activation functions, and setting up neural network layers.

In an embodiment, evaluation and tuning module 428 incorporates dynamic feedback mechanisms and facilitates continuous model evolution to help ensure the system's relevance and accuracy as the data landscape changes. Evaluation and tuning module 428 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 428 performs continuous model tuning by using hyperparameter optimization. Evaluation and tuning module 428 performs an exploration of the hyperparameter space using algorithms, such as grid search, random search, or more sophisticated methods like Bayesian optimization. Evaluation and tuning module 428 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 428 integrates data feedback and updates the model. Evaluation and tuning module 428 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 428 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 428 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 430 transforms data raw data into actionable, precise, and contextually relevant predictions. In addition to processing and applying a trained model to new data, inference module 430 may also include post-processing logic that refines the raw outputs of the model into meaningful insights.

In an embodiment, inference module 430 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 430 transforms the outputs of a trained model into definitive classifications. Inference module 430 employs the underlying model as a tool to generate probabilistic outputs for each potential class. It then engages in an interpretative process to convert these probabilities into concrete class labels.

In an embodiment, when inference module 430 receives the probabilistic outputs from the model, it analyzes these probabilities to determine how they are distributed across some or every potential class. If the highest probability is not significantly greater than the others, inference module 430 may determine that there is ambiguity or interpret this as a lack of confidence displayed by the model.

In an embodiment, inference module 430 uses thresholding techniques for applications where making a definitive decision based on the highest probability might not suffice due to the critical nature of the decision. In such cases, inference module 430 assesses if the highest probability surpasses a certain confidence threshold that is predetermined based on the specific requirements of the application. If the probabilities do not meet this threshold, inference module 430 may flag the result as uncertain or defer the decision to a human expert. Inference module 430 dynamically adjusts the decision thresholds based on the sensitivity and specificity requirements of the application, subject to calibration for balancing the trade-offs between false positives and false negatives.

In accordance with an embodiment, inference module 430 contextualizes the probability distribution against the backdrop of the specific application. This involves a comparative analysis, especially in instances where multiple classes have similar probability scores, to deduce the most plausible classification. In an embodiment, inference module 430 may incorporate additional decision-making rules or contextual information to guide this analysis, ensuring that the classification aligns with the practical and contextual nuances of the application.

In regression models, where the outputs are continuous values, inference module 430 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 430 incorporates domain-specific adjustments into its post-processing routine. This involves tailoring the model's output to align with specific industry knowledge or contextual information. For example, in financial forecasting, inference module 430 may adjust predictions based on current market trends, economic indicators, or recent significant events, ensuring that the outputs are both statistically accurate and practically relevant.

In an embodiment, inference module 430 includes logic to handle uncertainty and ambiguity in the model's predictions. In cases where inference module 430 outputs a measure of uncertainty, such as in Bayesian inference models, inference module 430 interprets these uncertainty measures by converting probabilistic distributions or confidence intervals into a format that can be easily understood and acted upon. This provides users with both a prediction and an insight into the confidence level of that prediction. In an embodiment, inference module 430 includes mechanisms for involving human oversight or integrating the instance into a feedback loop for subsequent analysis and model refinement.

In an embodiment, inference module 430 formats the final predictions for end-user consumption. Predictions are converted into visualizations, user-friendly reports, or interactive interfaces. In some systems, like recommendation engines, inference module 430 also integrates feedback mechanisms, where user responses to the predictions are used to continually refine and improve the model, creating a dynamic, self-improving system.

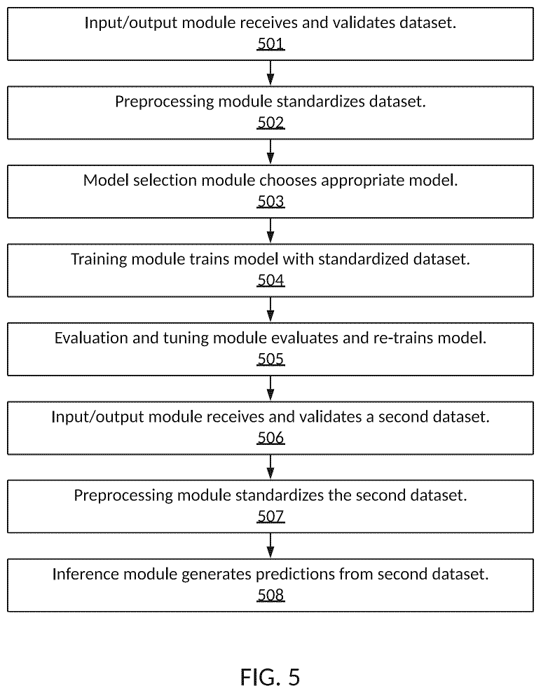

FIG. 5 illustrates the operation of a machine learning engine in one or more embodiments. In an embodiment, input/output module 420 receives a dataset intended for training (Operation 501). This data can originate from diverse sources, like databases or real-time data streams, and in varied formats, such as CSV, JSON, or XML. Input/output module 420 assesses and validates the data, ensuring its integrity by checking for consistency, data ranges, and types.

In an embodiment, training data is passed to data preprocessing module 422. Here, the data undergoes a series of transformations to standardize and clean it, making it suitable for training ML models (Operation 502). This involves normalizing numerical data, encoding categorical variables, and handling missing values through techniques like imputation.

In an embodiment, prepared data from the data preprocessing module 422 is then fed into model selection module 424 (Operation 503). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 426 trains the selected model with the prepared dataset (Operation 504). It implements learning algorithms to adjust the model's internal parameters, optimizing them to identify patterns and relationships in the training data. Training module 426 also addresses the challenge of overfitting by implementing techniques, like regularization and early stopping, ensuring the model's generalizability.

In an embodiment, evaluation and tuning module 428 evaluates the trained model's performance using the validation dataset (Operation 505). Evaluation and tuning module 428 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 420 receives a dataset intended for inference. Input/output module 420 assesses and validates the data (Operation 506).

In an embodiment, data preprocessing module 422 receives the validated dataset intended for inference (Operation 507). Data preprocessing module 422 ensures that the data format used in training is replicated for the new inference data, maintaining consistency and accuracy for the model's predictions.

In an embodiment, inference module 430 processes the new data set intended for inference, using the trained and tuned model (Operation 508). It applies the model to this data, generating raw probabilistic outputs for predictions. Inference module 430 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 440 allows for applications to leverage machine learning engine 400. In an embodiment, machine learning engine API 440 may be built on a RESTful architecture and offer stateless interactions over standard HTTP/HTTPS protocols. Machine learning engine API 440 may feature a variety of endpoints, each tailored to a specific function within machine learning engine 400. In an embodiment, endpoints such as/submitData facilitate the submission of new data for processing, while/retrieveResults is designed for fetching the outcomes of data analysis or model predictions. The MLE API may also include endpoints like/updateModel for model modifications and/trainModel to initiate training with new datasets.

In an embodiment, machine learning engine API 440 is equipped to support SOAP-based interactions. This extension involves defining a WSDL (Web Services Description Language) document that outlines the API's operations and the structure of request and response messages. In an embodiment, machine learning engine API 440 supports various data formats and communication styles. In an embodiment, machine learning engine API 440 endpoints may handle requests in JSON format or any other suitable format. For example, machine learning engine API 440 may process XML, and it may also be engineered to handle more compact and efficient data formats, such as Protocol Buffers or Avro, for use in bandwidth-limited scenarios.

In an embodiment, machine learning engine API 440 is designed to integrate WebSocket technology for applications necessitating real-time data processing and immediate feedback. This integration enables a continuous, bi-directional communication channel for a dynamic and interactive data exchange between the application and machine learning engine 400.

### 6. Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a SoftMax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 420, when used for large language models, handles textual data, converting input text into a format that the model can process. This typically involves tokenization, where the text is broken down into manageable pieces, such as words or sub words, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 422 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 424, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 426, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 428 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 430, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

The self-attention mechanism, which is part of a transformer network, enables the model to weigh the importance of different elements within an input sequence, regardless of their position. This allows the model to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data, and encoding inputs into a latent space, and generating outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 7. Practical Applications, Advantages, and Improvements

Embodiments provide several practical applications, advantages, and improvements over existing methods of conversational query processing. These advantages and improvements include the following:

Improved accuracy: Embodiments more accurately resolve queries using a multi-turn hybrid retrieval KB system by classifying a response generation of input queries into one of three methods: (1) predefined response, (2) RAG system generated response, or (3) hybrid response using both the predefined response and RAG system generated response. The system reduces the chances of hallucinations for common queries that fall into the first method above by leveraging predefined responses while still utilizing a RAG system for more complex queries.

Increased speed: Embodiments reduce the latency of responding to queries by utilizing the hybrid retrieval KB system. The system generates predefined responses with minimal latency compared to RAG systems. By avoiding retrieval of external data sources and text generation, the system reduces computational overhead and response time, enabling faster delivery of answers to user queries.

Increased efficiency: Embodiments reduce computational resource usage associated with query response generation. Because predefined responses are stored and indexed in advance, the system can satisfy a subset of queries through lightweight similarity comparisons rather than executing resource-intensive retrieval and generation processes. This selective use of predefined responses lowers processing costs and allows computational resources to be allocated more efficiently across multi-turn queries.

Improved multi-turn coherence: Embodiments track evolving intents across multiple conversations with memory-augmented embeddings and attention, improving context continuity and reducing misinterpretation in multi-turn conversations. The system stores and references previous queries and corresponding responses, increasing coherence in complex dialogue scenarios.

The data input to any ML model and/or the data output from any ML model, as described herein, may be used for operations performed by one or more of the following: Database Software, Cloud Infrastructure Software, Customer Relationship Management Software, Data Science Software, Digital Assistant Software, Vision Software, Language Software, Speech Software, Forecasting Software, Enterprise Software, Middleware, Server Software, Identity Management Software, Application Development Software, Analytics Software, Security Software, Data Integration Software, Health Software, Hospitality Software, Retail Software, Utilities Software, Operating Systems, Virtualization Software, Governance and Administration Software, Migration & Disaster Recovery Software, Networking Software, Connectivity Software, Monitoring Software, Procurement Software, Project Management Software, Risk Management Software, Supply Chain Management Software, Manufacturing Software, Human Capital Management Software, Customer Experience Software, Advertising Software, and Industry-Specific Application Software.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as execution of a particular application and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 9. Microservice Applications

According to one or more embodiments, the techniques described herein are implemented in a microservice architecture. A microservice in this context refers to software logic designed to be independently deployable, having endpoints that may be logically coupled to other microservices to build a variety of applications. Applications built using microservices are distinct from monolithic applications. Monolithic applications are designed as a single fixed unit and generally comprise a single logical executable. With microservice applications, different microservices are independently deployable as separate executables. Microservices may communicate using HyperText Transfer Protocol (HTTP) messages and/or according to other communication protocols via API endpoints. Microservices may be managed and updated separately, written in different languages, and be executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may additionally, or alternatively, provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

In one or more embodiments, microservices may be connected via a GUI. For example, microservices may be displayed as logical blocks within a window, frame, other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.)

### Triggers

The techniques described above may be encapsulated into a microservice, according to one or more embodiments. In other words, a microservice may trigger a notification (into the microservices manager for optional use by other plugged in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects a value has crossed a triggering threshold.

In one embodiment, the trigger, when satisfied, might output data for consumption by the target microservice. In another embodiment, the trigger, when satisfied, outputs a binary value indicating the trigger has been satisfied, or outputs the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### Actions

In one or more embodiments, a plugged-in microservice application may expose actions to the microservices manager. The exposed actions may receive, as input, data or an identification of a data object or location of data, that causes data to be moved into a data cloud.

In one or more embodiments, the exposed actions may receive, as input, a request to increase or decrease existing alert thresholds. The input might identify existing in-application alert thresholds and whether to increase or decrease, or delete the threshold. Additionally, or alternatively, the input might request the microservice application to create new in-application alert thresholds. The in-application alerts may trigger alerts to the user while logged into the application, or may trigger alerts to the user using default or user-selected alert mechanisms available within the microservice application itself, rather than through other applications plugged into the microservices manager.

In one or more embodiments, the microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 10. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

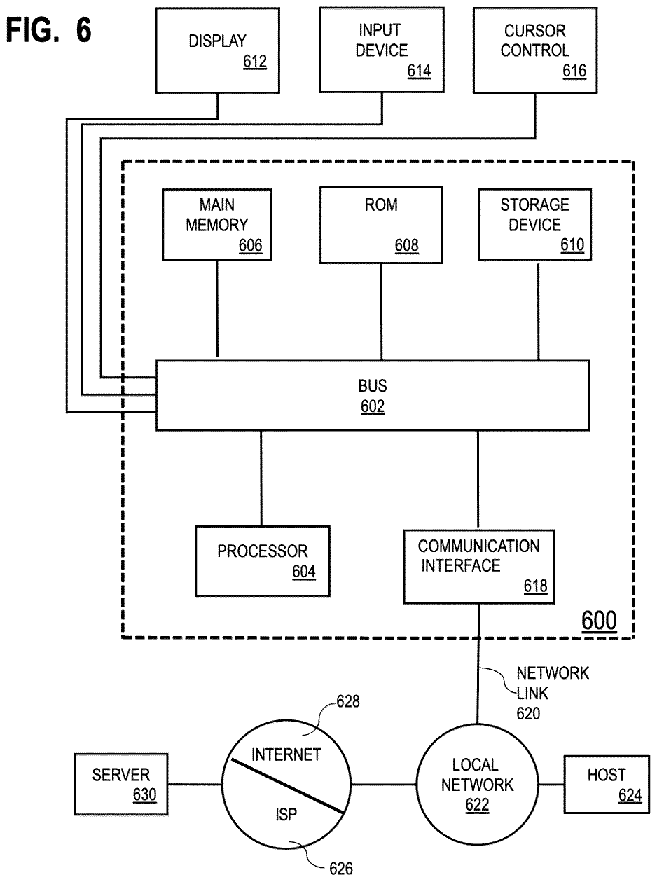

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general-purpose microprocessor.

Computer system 600 also includes a main memory 606, such as a random-access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read-only memory (ROM) 608 or other static storage device coupled to bus 602 for storing static information and instructions for processor 604. A storage device 610, such as a magnetic disk, optical disk, or a solid-state drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, SSD, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infrared data communications.

Various forms of media may be involved in carrying one or more sequences of one or more instructions to processor 604 for execution. For example, the instructions may initially be carried on a magnetic disk or SSD of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 11. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, a computer program product includes instructions that, when executed by one or more hardware processors, causes performance of any of the operations described herein and/or recited in any of the claims.

In an embodiment, one or more non-transitory computer-readable storage media store instructions that, when executed by one or more hardware processors, cause performance of any of the operations described herein and/or recited in any of the claims. As used herein, the term “non-transitory computer-readable medium” refers to any tangible storage medium that stores computer-executable instructions for execution by one or more hardware processors in a computing device(s). The term “non-transitory” excludes transitory, propagating signals per se, such as carrier waves or other electromagnetic signals, but includes all forms of physical storage media.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method comprising:
generating, by a knowledge base (KB) system, a first plurality of confidence scores corresponding to respective comparisons of a first user query with a plurality of intents;
determining, by the KB system, that a first confidence score of the first plurality of confidence scores, associated with a first intent of the plurality of intents, is in a high-confidence range of a plurality of confidence ranges;
responsive to determining that the first confidence score is in the high-confidence range:
generating, by the KB system, a first response to the first user query comprising a first predefined response associated with the first intent;
generating, by the KB system, a second plurality of confidence scores corresponding to respective comparisons of a second user query with the plurality of intents;
determining, by the KB system, that a second confidence score of the second plurality of confidence scores is in a low-confidence range of the plurality of confidence ranges;
responsive to determining that the second confidence score is in the low-confidence range:
identifying, by the KB system based on the second user query, a first knowledge base document;
generating, by the KB system, a second response to the second user query at least by applying a language model (LM) to the second user query and the first knowledge base document;
wherein the method is performed by at least one device including a hardware processor.

2. The method of claim 1, further comprising:
generating, by the KB system, a third plurality of confidence scores corresponding to respective comparisons of a third user query with the plurality of intents;
determining, by the KB system, that a third confidence score of the third plurality of confidence scores, associated with a second intent of the plurality of intents, is in an intermediate-confidence range of the plurality of confidence ranges;
responsive to determining that the third confidence score is in the intermediate-confidence range:
generating, by the KB system, a second predefined response associated with the second intent;
identifying, by the KB system based on the third user query, a second knowledge base document;
generating, by the KB system, a third response to the third user query at least by applying the language model (LM) to the third user query, the second predefined response, and the second knowledge base document.

3. The method of claim 1, further comprising:
generating, by the KB system, a third plurality of confidence scores corresponding to respective comparisons of a third user query with the plurality of intents;
determining, by the KB system, that a third confidence score of the third plurality of confidence scores is in an intermediate-confidence range of the plurality of confidence ranges, the intermediate-confidence range being between the high-confidence range and the low-confidence range;
responsive to determining that the third confidence score is in the intermediate-confidence range:
generating a first candidate response comprising a second predefined response associated with an intent corresponding to the third confidence score,
identifying, by the KB system based on the third user query, a second knowledge base document, and generating a second candidate response at least by applying the language model (LM) to the third user query and the second knowledge base document,
determining a blending weight that is a function of the third confidence score, and
generating a third response to the third user query at least by applying the LM to the first candidate response, the second candidate response, and data indicative of the blending weight.

4. The method of claim 1, wherein the first confidence score is a highest confidence score of the first plurality of confidence scores; and
wherein the second confidence score is a highest confidence score of the second plurality of confidence scores.

5. The method of claim 1, further comprising:
generating an embedding of the first user query with a query history;
wherein generating the first plurality of confidence scores is based at least in part on the embedding.

6. The method of claim 1, further comprising:
generating an embedding of the second user query with a query history;
wherein generating the second plurality of confidence scores is based at least in part on the embedding.

7. The method of claim 1, further comprising:
receiving user feedback on the first response to the first user query;
updating the high-confidence range based on the user feedback.

8. The method of claim 1, further comprising:
receiving user feedback on the first response to the first user query, wherein the user feedback comprises positive feedback and negative feedback;
responsive to determining that the negative feedback is greater than the positive feedback:
increasing a lower end of the high-confidence range.

9. The method of claim 1, wherein generating, by the KB system, the second response, further comprises:
retrieving, based on the first user query, one or more prior queries and corresponding responses;
generating, by the KB system, the second response to the second user query at least by applying the LM to the second user query, the first knowledge base document, and the one or more prior queries and corresponding responses.

10. The method of claim 1, wherein the respective comparisons of the first user query with the plurality of intents are performed between corresponding embeddings of the first user query and the plurality of intents.

11. A system comprising:
generating, by a knowledge base (KB) system, a first plurality of confidence scores corresponding to respective comparisons of a first user query with a plurality of intents;
determining, by the KB system, that a first confidence score of the first plurality of confidence scores, associated with a first intent of the plurality of intents, is in a high-confidence range of a plurality of confidence ranges;
responsive to determining that the first confidence score is in the high-confidence range:
generating, by the KB system, a first response to the first user query comprising a first predefined response associated with the first intent;
generating, by the KB system, a second plurality of confidence scores corresponding to respective comparisons of a second user query with the plurality of intents;
determining, by the KB system, that a second confidence score of the second plurality of confidence scores is in a low-confidence range of the plurality of confidence ranges;
responsive to determining that the second confidence score is in the low-confidence range:
identifying, by the KB system based on the second user query, a first knowledge base document;
generating, by the KB system, a second response to the second user query at least by applying a language model (LM) to the second user query and the first knowledge base document.

12. The system of claim 11, further comprising:
generating, by the KB system, a third plurality of confidence scores corresponding to respective comparisons of a third user query with the plurality of intents;
determining, by the KB system, that a third confidence score of the third plurality of confidence scores, associated with a second intent of the plurality of intents, is in an intermediate-confidence range of the plurality of confidence ranges;
responsive to determining that the third confidence score is in the intermediate-confidence range:
generating, by the KB system, a second predefined response associated with the second intent;
identifying, by the KB system based on the third user query, a second knowledge base document;
generating, by the KB system, a third response to the third user query at least by applying the language model (LM) to the third user query, the second predefined response, and the second knowledge base document.

13. The system of claim 11, further comprising:
generating, by the KB system, a third plurality of confidence scores corresponding to respective comparisons of a third user query with the plurality of intents;
determining, by the KB system, that a third confidence score of the third plurality of confidence scores is in an intermediate-confidence range of the plurality of confidence ranges, the intermediate-confidence range being between the high-confidence range and the low-confidence range;
responsive to determining that the third confidence score is in the intermediate-confidence range:
generating a first candidate response comprising a second predefined response associated with an intent corresponding to the third confidence score,
identifying, by the KB system based on the third user query, a second knowledge base document, and generating a second candidate response at least by applying the language model (LM) to the third user query and the second knowledge base document,
determining a blending weight that is a function of the third confidence score, and
generating a third response to the third user query at least by applying the LM to the first candidate response, the second candidate response, and data indicative of the blending weight.

14. The system of claim 11, wherein the first confidence score is a highest confidence score of the first plurality of confidence scores; and
wherein the second confidence score is a highest confidence score of the second plurality of confidence scores.

15. The system of claim 11, further comprising:
generating an embedding of the first user query with a query history;
wherein generating the first plurality of confidence scores is based at least in part on the embedding.

16. The system of claim 11, further comprising:
generating an embedding of the second user query with a query history;
wherein generating the second plurality of confidence scores is based at least in part on the embedding.

17. The system of claim 11, further comprising:
receiving user feedback on the first response to the first user query;
updating the high-confidence range based on the user feedback.

18. The system of claim 11, further comprising:
receiving user feedback on the first response to the first user query, wherein the user feedback comprises positive feedback and negative feedback;
responsive to determining that the negative feedback is greater than the positive feedback:
increasing a lower end of the high-confidence range.

19. The system of claim 11, wherein generating, by the KB system, the second response, further comprises:
retrieving, based on the first user query, one or more prior queries and corresponding responses;
generating, by the KB system, the second response to the second user query at least by applying the LM to the second user query, the first knowledge base document, and the one or more prior queries and corresponding responses.

20. One or more non-transitory computer-readable media comprising instructions that, when executed by one or more hardware processors, cause performance of operations comprising:
generating, by a knowledge base (KB) system, a first plurality of confidence scores corresponding to respective comparisons of a first user query with a plurality of intents;
determining, by the KB system, that a first confidence score of the first plurality of confidence scores, associated with a first intent of the plurality of intents, is in a high-confidence range of a plurality of confidence ranges;
responsive to determining that the first confidence score is in the high-confidence range:
generating, by the KB system, a first response to the first user query comprising a first predefined response associated with the first intent;
generating, by the KB system, a second plurality of confidence scores corresponding to respective comparisons of a second user query with the plurality of intents;
determining, by the KB system, that a second confidence score of the second plurality of confidence scores is in a low-confidence range of the plurality of confidence ranges;
responsive to determining that the second confidence score is in the low-confidence range:
identifying, by the KB system based on the second user query, a first knowledge base document;
generating, by the KB system, a second response to the second user query at least by applying a language model (LM) to the second user query and the first knowledge base document.
